(19) United States
(12) Patent Application Publication
(10) Pub. No.: US 2004/0165758 A1
(43) Pub. Date: Aug. 26, 2004

(54) MRI apparatus and method for adjusting MR image display parameters

(75) Inventors: Naoyuki Furudate, Tokyo (JP); Takeshiro Suzuki, Tokyo (JP)

Correspondence Address: NIXON & VANDERHYE, PC, 1100 N GLEBE ROAD, 8TH FLOOR, ARLINGTON, VA, 22201-4714, US

(73) Assignee: Kabushiki Kaisha Toshiba, Tokyo (JP)

(21) Appl. No.: 10/627,963

(22) Filed: Jul. 28, 2003

(30) Foreign Application Priority Data
Jul. 26, 2002 (JP) 2002-218637

(51) Int. Cl. G06K 9/00

(52) U.S. Cl. 382/132

(57) ABSTRACT

A method for adjusting the display of an MR image includes selecting a subset from a plurality of related MR images, setting at least one of window width and window level display parameters of the selected MR image(s), generating an equation for the parameter as a function of position in the sequence based on the set window width(s) or the window level(s), and then automatically setting window width(s) or window level(s) of other of the plurality of related MR images based on the equation.

### CROSS-REFERENCE TO RELATED APPLICATIONS

This application is based upon and claims the benefit of priority from prior Japanese Patent Application No. P2002-218637 filed on Jul. 26, 2002, the entire contents of which are incorporated herein by reference.

### FIELD OF THE INVENTION

The present invention is related to magnetic resonance imaging (MRI) apparatus and method for obtaining and adjusting an MR image of an object using the magnetic resonance phenomenon of nuclear spin.

### BACKGROUND OF THE INVENTION

In magnetic resonance imaging, nuclear spin in a patient in a static (but sequentially changed to different spatial distribution between image data acquisition events) magnetic field is magnetically excited by a radio frequency signal at the Larmor frequency. An MR image is created by a free induction decay (FID) or echo signal (e.g., a spin echo, a gradient eceho, etc.) generated by the excited nuclear spin. Magnetic resonance imaging is very useful for obtaining a tomographic image of the patient that is noninvasive or less-invasive than other techniques. Each pixel value of the MR image obtained such MRI techniques as multi-slice imaging, is strongly influenced by the volume of an area of interest in the MR image or by content (internal organs) unlike the pixel value of an image obtained by a CT apparatus. Therefore each MRI pixel value may be different for every image, even if imaging is performed using the same imposed conditions. For this reason, brightness values of a plurality of MR images are adjusted by setting a display window in order to easily observe the area of interest. The brightness value is from 0 (dark) to 255 (bright) when the number of gradation levels is 256, for example. The display window is set by a window level (hereinafter referred to as WL) that indicates a central value for the displayed brightness value and by a window width (hereinafter referred to as WW) that indicates a width value for the displayed brightness value, for example. In conventional MRI apparatus, the WL and WW parameters for every image obtained by multi-slice imaging are adjusted for each image or each group of images.

Thus, it may take much time to set WW and WL for each image since it may be necessary to make adjustments that equal twice the number of images. Otherwise, although the adjustment time can be reduced by simultaneously setting WW and WL for a group of the MR images, it is difficult in this case to minutely set WW and WL and to display the MR images at appropriate brightness—especially as the number of images in the group is increased.

### SUMMARY OF THE INVENTION

The present invention intends to reduce the above-mentioned problems. One aspect of the present invention involves deriving one or more equations for automatically adjusting image display parameters (e.g., image brightness range) for a plurality of images based on adjustments specifically selected for only a subset of those images. In the exemplary embodiment, the expected continuous nature of brightness parameters across a sequence of related images (e.g., as in a series of contiguous slice images) permits a continuous-valued curve-fitted equation to be used to automatically determine display parameters for the rest of the images, by fitting a continuous curve to data points representing manually adjusted values for a few images of the group.

In an exemplary method for automatically adjusting a display parameter for at least some of a sequence of related MR images, the method may include: (a) manually setting at least one display parameter for a subset of a sequence of related MR images; (b) generating at least one equation representing each said at least one display parameter as a function of MR image location in the sequence based on the manually set parameter value(s) for the subset; and (c) using the generated equation(s) to automatically determine and set the at least one display parameter for the MR images of the sequence not in the subset.

The at least one display parameter may be display brightness window width (WW) and/or display brightness window level (WL).

The equation generated for each display parameter (e.g., WW and/or WL) may be a quadratic equation fitted to the manually set parameter values of the subset.

The subset may be automatically selected from the sequence in accordance with a predetermined algorithm.

The subset may include three images, one being at or near a first end of the sequence, one being at or near the second end of the sequence and one being at or near the middle of the sequence.

The manual setting may include movements of a user input device (e.g., a mouse) in direction and/or magnitude that correspond to user-commanded changes in the at least one display parameter for a selected image of the subset.

### BRIEF DESCRIPTION OF THE DRAWINGS

A more complete appreciation of the invention and many of the attendant advantages thereof will be readily obtained as the same becomes better understood by reference to the detailed description when considered in connection with the accompanying drawings. Wherever possible, the same reference numbers will be used throughout the drawings to the same or the like parts. In the drawings:

FIG. 1 is a block diagram of an exemplary MRI apparatus;

FIG. 2 is an illustration for explaining an exemplary method for obtaining WW and WL for other MR images from a subset of three MR images using curve-fitted quadratic equations;

FIG. 3 is a flow chart showing an exemplary processing procedure for the case shown in FIG. 2;

FIG. 4 is an illustration for explaining an exemplary method for changing a coefficient of the quadratic equation; and

FIG. 5 is a flow chart showing an exemplary processing procedure for the case shown in FIG. 4.

### DETAILED DESCRIPTION OF AN EXEMPLARY EMBODIMENT

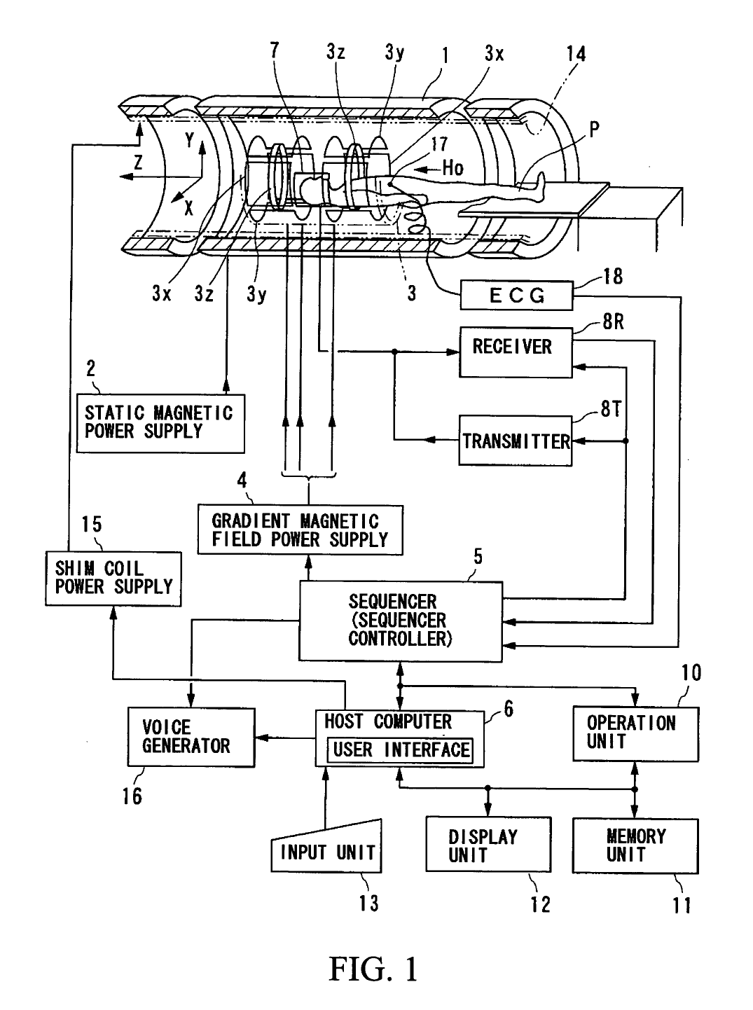

FIG. 1 is a block diagram of exemplary MRI apparatus. The exemplary MRI apparatus includes a bed unit on which a patient P is put, a static magnetic field generating unit for generating a static magnetic field and a gradient magnetic field generating unit for generating a gradient magnetic field. The MRI apparatus further includes a transceiver unit which transmits a radio frequency (RF) signal and receives an MR signal, and a control/operation unit which controls data acquisition processes and reconstructs an MR image. The static magnetic field generating unit includes a superconducting magnet 1, and a static magnetic power supply 2 which supplies current to the magnet 1. The static magnetic field generating unit generates the static magnetic field H0 in a direction (Z-axis direction) along an axis of a cylindrical opening (imaging space) where the patient P is inserted. The static magnetic field generating unit further includes a shim coil 14. A shim coil power supply 15 supplies current to the shim coil in order to improve uniformity of the static magnetic field under control of a controller. The bed unit includes a plate which is inserted into the opening of the magnet 1 with the patient P.

The gradient magnetic field generating unit includes a gradient magnetic field coil unit 3 attached to the magnet 1, for example. The gradient magnetic field coil unit 3 includes 3 sets (kinds) of coils that are x, y, z coils (3x to 3z) for generating the gradient magnetic field in X, Y, Z directions which are mutually perpendicular, and a gradient magnetic field power supply 4 that supplies current to the x, y, z coils (3x to 3z). The gradient magnetic field power supply 4 supplies a pulse current, under control of a sequencer 5, in order that the x, y and z coils 3x to 3z generate gradient magnetic fields. By controlling the pulse current supplied to the x, y and z coils 3x to 3z from the gradient magnetic field power supply 4, the gradient magnetic field of three axes (X, Y and Z axes) as physical axes are combined to arbitrarily set or adjust a slice direction gradient magnetic field GS, a phase encoding direction gradient magnetic field GE, and a read-out direction (frequency encoding direction) gradient magnetic field GR along logical axes. Each gradient magnetic field of the slice direction, the phase encoding direction and the read-out direction is combined with the static magnetic field H0 to produce a predetermined (programmable) net magnetic field spatial distribution in the imaged volume during the time of a corresponding MR signal acquisition.

The transceiver unit includes RF coil 7 positioned near the patient P in the imaging space of magnet 1, and transmitter 8T and receiver 8R which are connected to RF coil 7. The transmitter 8T supplies RF pulse current at the Larmor frequency to RF coil 7, in order to create a magnetic resonance (MR) phenomenon, under control of sequencer 5. The receiver receives the radio frequency MR signal via RF coil 7. The received MR signal is processed to form a corresponding digital signal. Although the exemplary RF coil 7 has dual functions (as a transmitting coil and as a receiving coil, for example), separate transmitting and receiving coils may be used if desired.

The control/operation unit includes the sequencer (typically called a sequence controller) 5, host computer 6, operation unit 10, memory unit 11, display unit 12, and input unit 13. The host computer 6 controls the whole system including sequencer 5, operation unit 10, memory unit 11, and display unit 12, for example. In addition, host computer 6 is used as a user interface when a scanning plan is designed. That is, host computer 6 receives instruction information from an operator based on the procedure defined by a stored program. The host computer 6 works with display unit 12 and input unit 13 as an interactive user interface for sending pulse sequence information created based on the instruction information to sequencer 5. The sequencer 5 includes a CPU and a memory which stores pulse sequence information sent from the host computer 6. The sequencer 5 controls a series of operations of gradient magnetic field power supply 4, transmitter 8T and receiver 8R based on the pulse sequence information. Moreover, sequencer 5 temporarily stores digital data of the MR signal from receiver 8R, and transmits data to operation unit 10 which performs reconstruction processing. The pulse sequence information is used for operating gradient magnetic field power supply 4, transmitter 8R and receiver 8T based on a series of pulse sequences. The pulse sequence information includes impression intensity, impression time and impression timing of the pulse current impressed to the x, y and z coils 3x to 3z, for example.

The operation unit 10 reads out raw data, arranges the raw data in Fourier space (called k space or frequency space), and performs averaging processing. Further, operation unit 10 performs reconstruction processing which changes the raw data to real space data (2 or 3-dimensional Fourier transform processing), and performs MIP (maximum intensity projection) processing to create a 2-dimensional image from a 3-dimensional image, in proper order. The memory unit 11 temporally stores the raw data, reconstructed image data, and also various kinds of data generated in related processes. The display unit 12 displays an MR image. The operator inputs information for setting an imaging condition, such as a scanning condition, a scan sequence and a method for processing, into host computer 6 by input unit 13. Furthermore, the control/operation unit includes a voice generator 16, ECG sensor 17 and ECG unit 18 as shown in FIG. 1. The voice generator 16 generates a voice message for a breath stop to the patient based on an instruction from sequencer 5 or host computer 6. The ECG sensor 17 and ECG unit 18 detect a patient's electrocardiogram signal and output the signal to sequencer 5 to perform synchronous imaging.

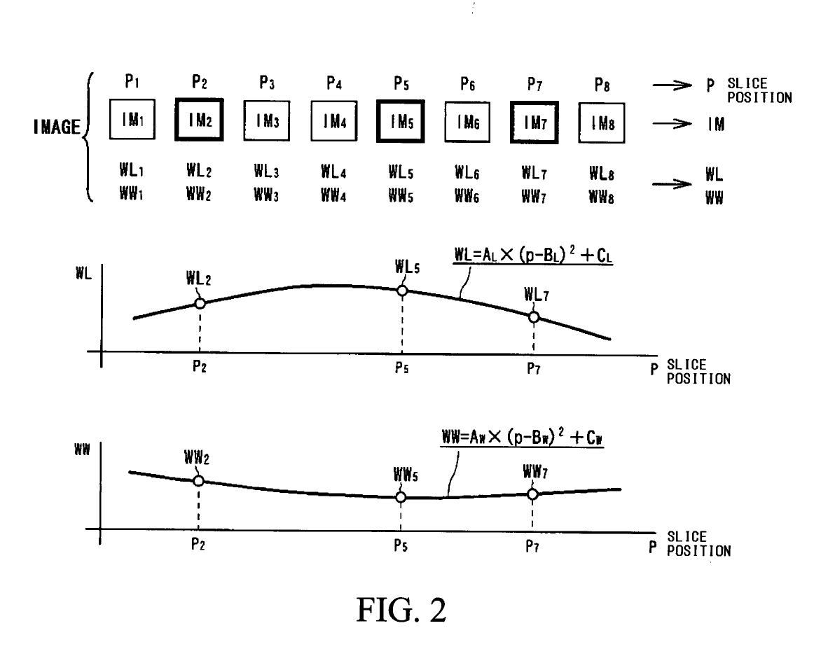

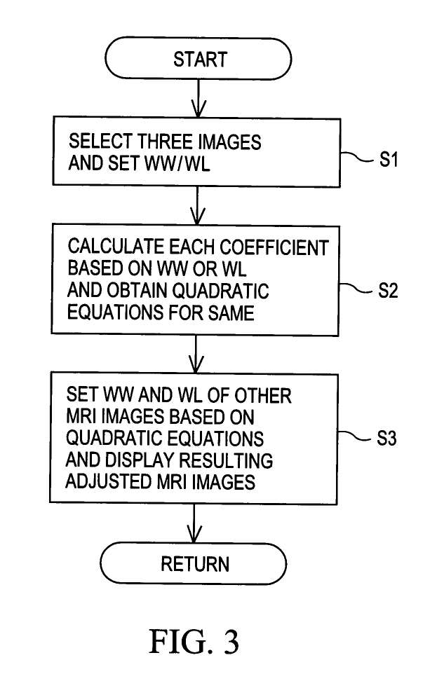

A method for setting WW and/or WL of the MR image is explained with reference to FIGS. 2 and 3 as one exemplary method for adjusting the MR image. Since each pixel value of the MR image obtained by contiguous multi-slice imaging has physical continuity between the successive images of a related sequence, each slice position influences the desired WL and WW value for each image. Equations of higher order are used for setting WL and WW by the user interface function performed by display unit 12, input unit 13 and host computer 6, for example. In this exemplary embodiment, the following formulas (1) and (2) of quadratic equations are used as one example of the above-mentioned equations of higher order.

WL=A_{L}×(P−B_{L})²+C_{L} Equation (1)

WW=A_{W}×(P−B_{W})²+C_{W} Equation (2)

In the above-mentioned equations (1) and (2), P represents the relative slice position of a display image in a related sequence of images and A_{L}, B_{L}, C_{L}, A_{W}, B_{W}, and C_{W} represent curve-fitted coefficients, respectively. An exemplary method for obtaining the above quadratic equation from three arbitrary images (i.e., a subset of the sequence) is explained with reference to FIG. 2 and FIG. 3. FIG. 2 and FIG. 3 show an illustration and a flow chart, respectively. As shown in FIG. 2, each MR image IM (IM1 to IM8) on each slice position P (P1 to P8) obtained by the MRI apparatus in a related sequence is displayed on display unit 12. Each WW and WL value (WW1/WL1 to WW8/WL8) for each MR image is set as described below. The setting of WW and WL values is performed by computer 6 as part of the user interface in this exemplary embodiment.

In FIG. 3, three MR images, such as IM2, IM5 and IM7, are arbitrarily selected from among the MR images IM1 to IM8, and the WW and WL parameters are manually set (Step S1) for each of these three images. That is, the operator selects these MR images and also sets the desired WW and WL values via the input unit 13, such as, but not limited to, a mouse device, observing the MR images IM1 to IM8. Based on the WW and WL settings for this subset of the sequence, each coefficient A_{L}, B_{L}, C_{L}, A_{W}, B_{W} and C_{W} of the above-mentioned equations (1) and (2) may be calculated using conventional curve fitting algorithms to generate the quadratic equations for WW and WL (Step S2). In FIG. 2, based on the manually set values WL2, WL5 and WL7 of three subset images IM2, IM5 and IM7, the coefficients A_{L}, B_{L}, and C_{L} in equation (1) are calculated (by curve fitting), and based on the manually set values WW2, WW5, and WW7, the coefficients A_{W}, B_{W}, and C_{W} in equation (2) are calculated, respectively. Based on these thus generated quadratic equations, WW and WL for all other MR images are automatically set (by simply solving these equations for each slice position P) and the thus adjusted images may all be displayed on display unit 12 (Step S3). That is, WW1/WL 1, WW3/WL3, WW4/WL4, WW6/WL6 and WW8/WL8 for initially non-selected MR images IM1, IM3, IM4, IM6 and IM8 in FIG. 2 are automatically set to adjusted values.

In this exemplary embodiment, since WW and WL of other MR images are effectively set all at once based on the desired WW and WL set for only three (or more if desired) arbitrarily selected MR images, each WW and WL is more easily or appropriately set in comparison with the conventional method where WW and WL parameters are set separately for each image or group of images. In addition, although quadratic equations are used in this exemplary embodiment, linear equations or other equation of other order(s), such as a cubic equation, may alternatively be used. If so, then the number of data points required to define such curve may vary as will be appreciated. Moreover, although three arbitrary images were manually selected by the operator in this exemplary embodiment, the required initial images may be automatically selected based on a predetermined selection condition. For example, three images (placed on both ending and central parts in a slice direction) may automatically be selected. Moreover, although the user interface for setting the WW and WL parameters of an image is created within and by the MRI apparatus itself in this exemplary embodiment, other processing or displaying apparatuses, such as, but not limited to, a workstation or a PC (personal computer) may alternatively include the user interface image adjustment feature(s) of this invention.

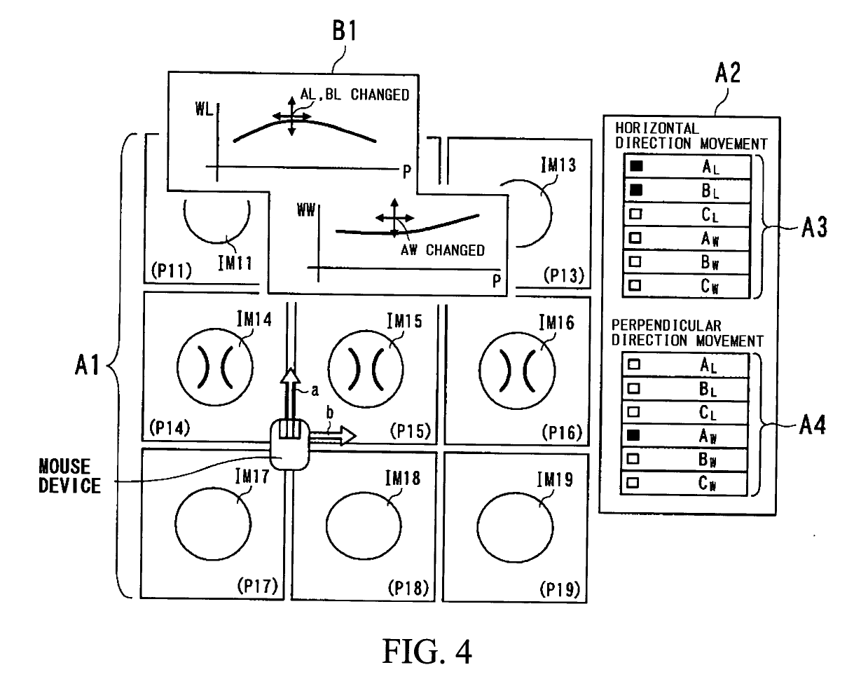

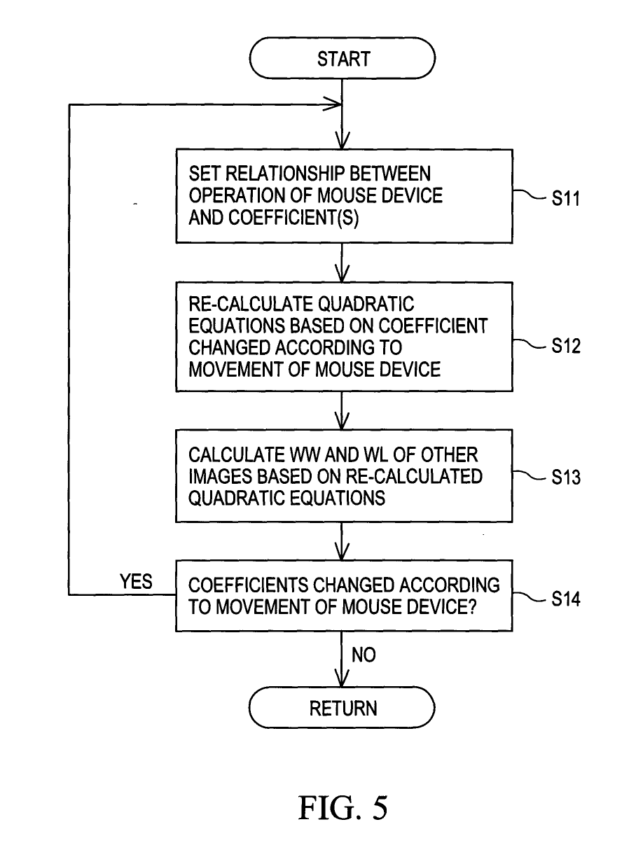

One modification of the above exemplary embodiment is explained with reference to FIGS. 4 and 5. FIG. 4 and FIG. 5 show an illustration and a flow chart, respectively. In this modification, the user interface including host computer 6, display unit 12 and input unit 13, has an additional function to directly change each coefficient (A_{L}, B_{L}, C_{L}, A_{W}, B_{W} and C_{W}) of the quadratic equations (1) and (2). As shown in FIG. 4, MR images IM11 to IM19 on each slice position P (P11 to P19) obtained by the MRI apparatus are displayed on display unit 12 in a predetermined display format. As one example of the display format, three images (horizontal direction)×three images (perpendicular direction) are displayed as shown in A1 on FIG. 4. The WW and WL parameters for these images are set. The setting is performed by host computer 6 via the user interface as shown in FIG. 5.

In FIG. 5, the operator sets a relationship between an operation of the mouse device and a coefficient (one or more coefficients) of the associated quadratic equation(s) via the user interface (Step S11). In detail, the operator sets, for example, perpendicular and horizontal directions for operation of the mouse device with respect to each coefficient A_{L}, B_{L}, C_{L}, A_{W}, B_{W} and C_{W} of the quadratic equation(s), observing operation screen A2 on display unit 12. In A3 and A4 on FIG. 4, a white square indicates non-selected and a black square indicates selected. In FIG. 4, coefficients A_{L} and B_{L} are related to a horizontal direction of mouse device movement and coefficient A_{W} is related to a perpendicular direction of mouse device movement. The operator moves the mouse device in the perpendicular direction A or the horizontal direction B, and the coefficient(s) of the quadratic equation(s) is (are) determined according to the direction and distance of the movement. In FIG. 4, when the operator moves the mouse device in perpendicular direction A, coefficients A_{L} and B_{L} are changed. When the operator moves the mouse device in horizontal direction B, coefficient A_{W} is changed. By thus changing the coefficients of the quadratic equation(s), the quadratic equation(s) is (are) re-calculated (Step S12).

Based on the re-calculated quadratic equation(s), the WW and/or WL parameters of other images are calculated and the thus adjusted images are displayed with the newly calculated WW and WL parameter values (Step S13). The changing of the other coefficient(s) may be repeated in the same way (Step S14). In this modification, since an additional function for changing coefficients A_{L}, B_{L}, C_{L}, A_{W}, B_{W} and C_{W} is provided, the WW and WL parameters can be set with perhaps greater speed, ease—and possibly to more appropriate desired values.

The present invention is not limited to the above exemplary embodiments and various modifications may be made without departing from the spirit or scope of the general inventive concepts. For example, the direction of the static magnetic field is along the longitudinal body axis of the patient in the exemplary embodiment may be realized with an MRI apparatus which creates the static magnetic field in a vertical direction. So-called “Open MRI” apparatus, may also be used. And, so-called “Short MRI” apparatus may be used. Moreover, although a superconducting magnet is used for generating the static magnetic field in the above exemplary embodiment, a permanent magnet may be applied. Other possible modifications and variations will be apparent to those in the art. In particular, so long as a related sequence of images is produced essentially any desired basic form of MRI apparatus may be used in conjunction with this invention.

According to the present invention, it is possible to more easily and/or more appropriately adjust at least the MR image brightness parameters.

What is claimed is:

1. A method for adjusting an MR image display parameter, said method comprising:
selecting at least one MR image from among a plurality of related MR images;
setting a display parameter of the at least one selected MR image;
generating a first equation based on the set display parameter; and
setting said display parameter for at least one other of said MR images based on the first equation.

2. A method as in claim 1 wherein said display parameter comprises a brightness window width.

3. A method as in claim 2, further comprising:
changing at least one coefficient of the first equation; and
resetting the brightness window width of the at least one other of said of MR image based on the changed coefficient.

4. A method as in claim 1, wherein the first equation is an equation of second or higher order.

5. A method as in claim 4, wherein the equation is a quadratic equation.

6. A method as in claim 1, further comprising:
setting a second display parameter for the selected MR image;
generating a second equation based on the set second display parameter; and
setting said second display parameter for at least one other of MR images based on the second equation.

7. A method as in claim 6 wherein said second display parameter comprises a brightness window level.

8. A method as in claim 7, further comprising:
changing at least one coefficient of the second equation; and
resetting the window level of the at least one other of the MR images based on the changed coefficient.

9. A method as in claim 7, wherein the second equation is an equation of second or higher order.

10. A method as in claim 9, wherein the second equation of higher order is a quadratic equation.

11. A computer program product configured to implement the method of clam 1.

12. A method for adjusting an MR image display parameter, said method comprising:
selecting at least one MR image from among a plurality of related MR images;
setting a brightness window level for the selected at least one MR image;
generating an equation based on the set window level; and
setting the window level of at least one other of said MR images based on the generated equation.

13. A method as in claim 12, further comprising:
changing at least one coefficient of the generated equation; and
resetting the window level for the at least one other of said MR images based on the changed coefficient.

14. A method as in claim 12, wherein the generated equation is an equation of second or higher order.

15. A method as in claim 14, wherein the generated equation is a quadratic equation.

16. A computer program product configured to implement the method of claim 12.

17. A method for adjusting an MR image display parameter, said method comprising:
displaying a plurality of related MR images;
selecting less than half of the displayed MR images;
setting a display parameter window width for the selected MR image(s);
setting a display parameter window level for the selected MR image(s);
generating a first equation based on the set window width(s);
generating a second equation based on the set window level(s);
setting a window width for MR images other than said selected MR images based on the first equation; and
setting a window level for MR images other than said selected MR images based on the second equation.

18. An MR apparatus comprising:
a static field generating unit configured to impress a static magnetic field on an object;
a gradient magnetic field generating unit configured to impress a gradient magnetic field on the object;
a transceiver unit configured to impress a radio frequency signal on the object and to receive an magnetic resonance radio frequency signal emanating from the object;
an operation unit configured to reconstruct a plurality of MR images based on the received magnetic resonance signal;
an input unit configured to select at least one among the plurality of MR images and configured to set a window width display parameter for the selected at least one MR image; and
a controller configured to generate a first equation based on the set window width parameter(s) and configured to the set window width parameter(s) for at least one other of said plurality of MR images based on the first equation.

19. An MRI apparatus as in claim 18, wherein:
the input unit is also configured to change at least one coefficient of the first equation; and
the controller is also configured to reset the window width parameter(s) of the at least one other of said plurality of MR images based on the changed coefficient.

20. An MRI apparatus as in claim 18, wherein:
the input unit is also configured to set a window level display parameter of the selected MR image(s); and
the controller is also configured to generate a second equation based on the set window level parameter(s) and configured to set the window level parameter(s) of at least one other of said plurality of MR images based on the second equation.

21. An MRI apparatus as in claim 20, wherein:
the input unit is also configured to change at least one coefficient of the second equation; and
the controller is also configured to reset the window level parameter of the at least one other of said plurality of MR images based on the changed coefficient.

22. An MRI apparatus comprising:
a static field generating unit configured to impress a static magnetic field on an object;
a gradient magnetic field generating unit configured to impress a gradient magnetic field on the object;
a transceiver unit configured to impress a radio frequency signal on the object and to receive an magnetic resonance radio frequency signal emanating from the object;
an operation unit configured to reconstruct a plurality of MR images based on the received magnetic resonance signal;
an input unit configured to select at least one among the plurality of MR images and configured to set a window level display parameter for the selected MR image; and
a controller configured to generate an equation based on the set window level parameter(s) and configured to set the window level parameter(s) for at least one other of said plurality of MR images based on the equation.

23. An MRI apparatus as in claim 22, wherein:
the input unit is also configured to change at least one coefficient of the generated equation; and
the controller is also configured to reset the window level parameter of the at least one other of said plurality of MR images based on the changed coefficient.

24. A method for adjusting an MR image, said method comprising:
selecting at least one from among a plurality of MR images;
setting a brightness value for the selected at least one MR image;
generating an equation based on the set brightness value(s); and
setting the brightness value(s) of at least one other of said plurality of MR images based on the generated equation.

25. An MRI apparatus comprising:
a static field generating unit configured to impress a static magnetic field on an object;
a gradient magnetic field generating unit configured to impress a gradient magnetic field on the object;
a transceiver unit configured to impress a radio frequency signal on the object and to receive an magnetic resonance radio frequency signal emanating from the object;
an operation unit configured to reconstruct a plurality of MR images based on the received magnetic resonance signal;
an input unit configured to select at least one from among the plurality of MR images and configured to set a brightness value for the selected MR image(s); and
a controller configured to generate an equation based on the set brightness value(s) and configured to set the brightness value(s) of at least one other of said plurality of MR images based on the generated equation.

26. A method for automatically adjusting a display parameter for at least some of a sequence of related MR images, said method comprising:
manually setting at least one display parameter for a subset of a sequence of related MR images;
generating at least one equation representing each said at least one display parameter as a function of MR image location in said sequence based on the manually set parameter value(s) for said subset; and
using said generated equation(s) to automatically determine and set said at least one display parameter for MR images of the sequence not in said subset.

27. A method as in claim 26 wherein said at least one display parameter comprises display brightness window width.

28. A method as in claim 27 wherein the equation generated for window width is a quadratic equation defining a curve fitted to the manually set window width values of said subset.

29. A method as in claim 26 wherein said at least one display parameter comprises display brightness window level.

30. A method as in claim 29 wherein the equation generated for window level is a quadratic equation defining a curve fitted to the manually set window level values of said subset.

31. A method as in claim 27 wherein said at least one display parameter comprises display brightness window level.

32. A method as in claim 28 wherein the equation generated for window level is a quadratic equation defining a curve fitted to the manually set window level values of said subset.

33. A method as in claim 26 wherein said subset is automatically selected from the sequence in accordance with a predetermined algorithm.

34. A method as in claim 33 wherein said subset comprises three images, one being at or near a first end of the sequence, one being at or near the second end of the sequence and one being at or near the middle of the sequence.

35. A method as in claim 26 wherein said manual setting includes movements of a user input device in direction and/or magnitude that correspond to user-commanded changes in said at least one display parameter for a selected image of the subset.

36. Apparatus for automatically adjusting a display parameter for at least some of a sequence of related MR images, said apparatus comprising:
means for manually setting at least one display parameter for a subset of a sequence of related MR images;
means for generating at least one equation representing each said at least one display parameter as a function of MR image location in said sequence based on the manually set parameter value(s) for said subset; and
means for using said generated equation(s) to automatically determine and set said at least one display parameter for MR images of the sequence not in said subset.

37. Apparatus as in claim 36 wherein said at least one display parameter comprises display brightness window width.

38. Apparatus as in claim 36 wherein the equation generated for window width is a quadratic equation defining a curve fitted to the manually set window width values of said subset.

39. Apparatus as in claim 36 wherein said at least one display parameter comprises display brightness window level.

40. Apparatus as in claim 39 wherein the equation generated for window level is a quadratic equation defining a curve fitted to the manually set window level values of said subset.

41. Apparatus as in claim 37 wherein said at least one display parameter comprises display brightness window level.

42. Apparatus as in claim 38 wherein the equation generated for window level is a quadratic equation fitted to the manually set window level values of said subset.

43. Apparatus as in claim 36 further comprising means for automatically selecting said subset from the sequence in accordance with a predetermined algorithm.

44. Apparatus as in claim 43 wherein said means for automatically selecting automatically selects a subset comprising three images, one being at or near a first end of the sequence, one being at or near the second end of the sequence and one being at or near the middle of the sequence.

45. Apparatus as in claim 36 wherein said means for manual setting includes movements of a user input device in direction and/or magnitude that correspond to user-commanded changes in said at least one display parameter for a selected image of the subset.

46. A method for adjusting an MR image display parameter, said method comprising:
selecting at least one MR image from among a plurality of related MR images;
setting a display parameter of the at least one selected MR image; and
setting said display parameter for at least one other of said MR images based on the set display parameter.
